(19) United States
(12) Patent Application Publication
(10) Pub. No.: US 2012/0047572 A1
(43) Pub. Date: Feb. 23, 2012

(54) DECAPSULATION OF DATA PACKET TUNNELS TO PROCESS ENCAPSULATED IPV4 OR IPV6 PACKETS

(76) Inventors: RICHARD JEREMY DUNCAN, Fairfax, VA (US); Ronald Scott Hulen, Ashburn, VA (US)

(21) Appl. No.: 12/857,759

(22) Filed: Aug. 17, 2010

(51) Int. Cl. G06F 21/20

(52) U.S. Cl. 726/13

(57) ABSTRACT

In one embodiment, a non-transitory processor-readable medium stores code representing instructions to cause a processor to determine whether an IPv4 payload of an IPv4 packet includes a tunneled IPv6 packet. When the IPv4 payload includes the tunneled IPv6 packet, the code can determine a location of a payload of the tunneled IPv6 packet based at least in part on a header of the tunneled IPv6 packet, and send a signal to block transmission of the IPv4 packet when the payload of the tunneled IPv6 packet is not a valid IPv6 payload.

### CROSS-REFERENCE TO RELATED APPLICATIONS

This application is related to co-pending U.S. Non-provisional patent applications bearing Attorney Docket Nos. COMM-004/00US and COMM-005/00US, each filed on the same date, and entitled “Systems and Methods for Detecting Preselected Query Type within a DNS Query” and “Methods and Apparatus for Detecting Invalid IPv6 Packets,” respectively, both of which are incorporated herein by reference in their entirety.

### BACKGROUND

Some embodiments described herein relate generally to the inspection and filtering of data packets, and more particularly to methods and apparatus for the inspection and filtering of tunneled Internet Protocol version 4 (IPv4) and Internet Protocol version 6 (IPv6) packets.

Known network protection and packet-filtering solutions perform analysis and inspection of incoming network communications so as to detect potentially malicious data packets. Known solutions fail to account for vulnerabilities inherent in many transition mechanisms defined to facilitate the Internet's transition from IPv4 to IPv6, however. Among these transition mechanisms are 6in4 encapsulation, Generic Routing Encapsulation (GRE), IPv6-in-UDP tunneling, and 4in6 encapsulation, each of which provides a potential vehicle through which malicious code may attempt to enter a network. Thus, a need exists for methods and apparatus to inspect incoming network data for potential threats included in packets defined according to one or more such IPv6 transition mechanisms.

### SUMMARY

In one embodiment, a non-transitory processor-readable medium stores code representing instructions to cause a processor to determine whether an IPv4 payload of an IPv4 packet includes a tunneled IPv6 packet. When the IPv4 payload includes the tunneled IPv6 packet, the code can determine a location of a payload of the tunneled IPv6 packet based at least in part on a header of the tunneled IPv6 packet, and send a signal to block transmission of the IPv4 packet when the payload of the tunneled IPv6 packet is not a valid IPv6 payload.

### BRIEF DESCRIPTION OF THE DRAWINGS

FIG. 1 is a schematic diagram that illustrates a tunneled packet filtering system, according to an embodiment.

FIG. 2 is a schematic diagram that illustrates a packet inspection unit, according to an embodiment.

FIG. 3 is a flow chart that illustrates a method of filtering a tunneled IPv6 packet encapsulated within an IPv4 packet based on one or more filter policies, according to an embodiment.

FIG. 4 is a flow chart that illustrates a method of filtering a tunneled packet encapsulated within an IPv6 packet based on one or more filter policies, according to an embodiment.

FIG. 5 is a flow chart that illustrates a method of blocking a received IPv4 packet upon determination that the received IPv4 packet contains four or more tunneled packets, according to an embodiment.

FIG. 6 is a flow chart that illustrates a method of filtering a tunneled Generic Routing Encapsulation (GRE) packet, according to an embodiment.

FIG. 7 is a schematic diagram that illustrates an example of an IPv6-in-UDP-tunneled IPv4 packet.

FIG. 8 is a schematic diagram that illustrates an example of an IPv4 or IPv6 packet that includes a Generic Routing Encapsulation (GRE) packet.

### DETAILED DESCRIPTION

In some embodiments, a gateway device located on the ingress side of a network can receive an IPv4 or IPv6 packet containing a “tunneled” (i.e., encapsulated) data packet. The gateway device can be operatively and/or physically coupled to one or more packet inspection units configured to inspect and apply filter policies to incoming data packets. In some embodiments, the gateway device can be further physically and/or operatively coupled to a policy unit configured to define and transmit such filter policies for translation by the gateway device and use by the one or more packet inspection units. In some embodiments, the gateway device can be operatively and/or physically coupled to a reporting and analysis unit configured to perform analysis on allowed and/or blocked data packets in individual instances and/or in aggregate.

Each packet inspection unit can be, for example, a hardware-based and/or software-based module or device configured to inspect incoming data packets for one or more IPv6 transition vulnerabilities. In some embodiments, the packet inspection unit can inspect a header and/or payload of an incoming data packet. The packet inspection unit can optionally be configured to inspect successive levels or layers of tunneled packets included in an incoming IPv4 or IPv6 data packet. In some embodiments, the packet inspection unit can receive one or more filter policies from the gateway device and/or the policy unit described above. In such embodiments, the packet inspection unit can apply one or more such filter policies subsequent to or as part of the packet inspection process. After applying the one or more filter policies, the packet inspection unit can next determine whether the inspected data packet should be blocked from access to the network, allowed into the network, or sent for further processing and analysis by another module or device within or outside the packet inspection unit.

In some embodiments, the packet inspection unit can use the one or more filter policies to detect the presence of one or more tunneled packets included in an incoming IPv4 packet. For example, in some embodiments a packet inspection unit can use a filter policy to detect a presence of a Generic Routing Encapsulation (GRE) tunnel, a 6in4 tunnel, an IPv6-in-UDP tunnel, a Tunnel Setup Protocol (TSP) tunnel, an IPinIP tunnel, and/or an Authentication Header (AH) tunnel. In some embodiments, the packet inspection unit can use one or more filter policies to detect the presence of one or more tunneled packets included in an incoming IPv6 packet. For example, in some embodiments a filter policy can detect a presence of a 4in6 tunnel, a 6in6 tunnel, a IPv6 GRE (“GREv6”) tunnel, and/or an IPv6 AH tunnel. In some embodiments, the packet inspection unit can use the one or more filter rules to determine whether an incoming IPv4 or IPv6 tunnel includes a preselected number of tunnels (i.e., successively encapsulated data packets).

In some embodiments, a packet inspection unit can use a filter policy to, upon detection of a tunnel, determine whether the tunneled packet, a portion thereof, and/or the incoming IPv4 or IPv6 data packet itself should be allowed into the network, blocked from entering the network, or sent to a subsequent module or device for further processing. For example, in some embodiments, a filter policy can dictate that, upon detection of a 6in4 packet within an incoming IPv4 data packet, the packet inspection unit and/or the gateway device should discard the IPv4 header and send the IPv4 payload (i.e., the encapsulated IPv6 packet) to an IPv6 processing module. In an additional example, a filter policy can dictate that, upon detection of four or more tunneled packets within an incoming IPv4 or IPv6 data packet, the packet inspection unit and/or the gateway device should discard the entire incoming data packet. In some embodiments, upon making such a determination, the packet inspection unit can send a signal to allow, block, or send the IPv4 packet. In some embodiments, this signal can be sent within the packet inspection unit so that the packet inspection unit blocks the IPv4 packet. In some other embodiments, the packet inspection unit can send one or more signals to the gateway device indicating that the appropriate action be taken on the incoming data packet. In some embodiments, the gateway device can receive the one or more signals indicating that an allow, block, or send action be taken and/or performed on the incoming data packet. In such embodiments, the gateway device can then allow, block, or send the incoming data packet based at least in part on the one or more signals. In some embodiments, the one or more signals can include, for example, a flag and/or indicator value defined to cause the gateway device to perform the allow, block, or send action on the incoming data packet.

In some embodiments, the policy unit can include a user interface that allows an individual, such as a network administrator, to define one or more filter policies for application by the one or more packet inspection units. In such embodiments, the policy unit can include a web interface. In some embodiments, the reporting and analysis unit can include a web and/or other interface configured to allow an individual, such as a network or system administrator, to generate one or more logs, reports, charts, graphs or other formatted data associated with the history of incoming data packets received and filtered by the gateway device and one or more packet inspection units.

As used in this specification, the singular forms “a,” “an” and “the” include plural referents unless the context clearly dictates otherwise. Thus, for example, the term “a module” is intended to mean a single module or a combination of modules.

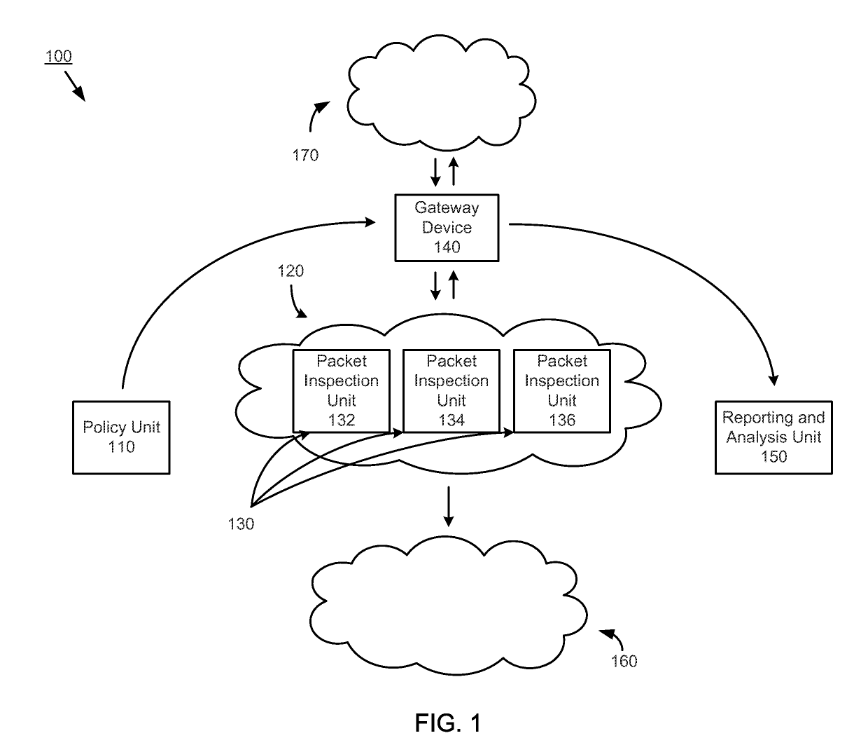

FIG. 1 is a schematic diagram that illustrates a tunneled packet filtering system, according to an embodiment. More specifically, FIG. 1 illustrates Tunneled Packet Filtering System 100. The Tunneled Packet Filtering System 100 includes Packet Inspection Unit 132, Packet Inspection Unit 134 and Packet Inspection Unit 136 (collectively referred to as Packet Inspection Units 130) included in a Packet Inspection Network 120 and each in communication with a Gateway Device 140 and a Client Network 160. The Gateway Device 140 is in further communication with a Policy Unit 110, a Reporting and Analysis Unit 150 and an External Network 170.

The Policy Unit 110 can be any combination of hardware and/or software (executing on hardware) configured to transmit one or more filter policies to one or more of the Packet Inspection Units 130. In some embodiments, the Policy Unit 110 can be operatively and/or physically coupled to the Gateway Device 140. For example, the Policy Unit 110 can be coupled to the Gateway Device 140 via a wired and/or wireless data connection, such as a wired Ethernet connection, a wireless 802.11x (“Wi-Fi”) connection, etc. In some embodiments, the Policy Unit 110 can be one of multiple such policy units included in the Tunneled Packet Filtering System 100. The Policy Unit 110 can optionally be or can be disposed within a server device (not shown in FIG. 1). In some embodiments, the Policy Unit 110 can be included in the same hardware device as the Gateway Device 140 and/or one or more of the Packet Inspection Units 130.

The Policy Unit 110 can optionally include a web-based interface that enables an administrator or other user of the Tunneled Packet Filtering System 100 to create, define, clone, import or export filter policies or other policies, rules, instructions or directives. In some embodiments, the Policy Unit 110 can transmit a filter policy to the Gateway Device 140. The filter policy can include one or more rules that define when various packets or packet types are to be allowed into the Packet Inspection Network 120, blocked therefrom, or sent for further processing before being ultimately allowed or blocked from the Packet Inspection Network 120. In some embodiments, the Policy Unit 110 can include one or more default filter policies.

The Packet Inspection Network 120 can be comprised of one or more packet inspection units, such as the Packet Inspection Units 130. In some embodiments, the Packet Inspection Network can include one or more switching and/or routing devices configured to direct network traffic (i.e., incoming data packets) received from the Gateway Device 140 to and/or between the Packet Inspection Units 130. In some embodiments, the one or more switching and/or routing devices can be configured to direct network traffic (including, e.g., filter results) from the Packet Inspection Units 130 to the Gateway Device 140.

The Packet Inspection Units 130 can each be any combination of hardware and/or software (executing on hardware) configured to apply one or more filter policies to one or more incoming data packets (not shown in FIG. 1). In some embodiments both the filter policies and incoming data packets can be received at the Packet Inspection Units via the Gateway Device 140. In some embodiments, the Packet Inspection Units 130 can each be configured to apply one or more filter policies to an incoming data packet to determine whether that data packet should be forwarded onto or permitted to be accessed by one or more other devices included in the Client Network 160. The Packet Inspection Units 130 can thus prevent potentially malicious data packets from reaching devices within the Client Network 160, and thereby thwart security breaches and/or other remote attacks. In some embodiments, the Packet Inspection Units 130 can include one or more hardware and/or software modules, such as third-party modules configured to inspect and/or apply filter policies or rules on incoming data packets.

In some embodiments, one or more of the Packet Inspection Units 130 can be a server computing device operatively and/or physically coupled to the Gateway Device 140. For example, the Packet Inspection Unit 134 can be coupled to the Gateway Device 140 via a wired and/or wireless data connection, such as a wired Ethernet connection, a wireless 802.11x (“Wi-Fi”) connection, and/or a WiMax, Ultra-wideband (UWB), Universal Serial Bus (USB), Bluetooth, infrared, cellular network, or other wireless data connection. In some embodiments, the Packet Inspection Unit 134 can be in communication with the Gateway Device 140 via one or more switching and/or routing devices (not shown) included in the Packet Inspection Network 120. In some embodiments, one or more of the Packet Inspection Units 130 can be included in a single device. In some embodiments, one or more of the Packet Inspection Units 130 can be included in the same hardware device as the Gateway Device 140, the Policy Unit 110 and/or the Reporting and Analysis Unit 150. Alternatively, one or more of the Packet Inspection Units 130 can be disposed within separate or distinct devices from one another and/or from the Gateway Device 140, the Policy Unit 110 and/or the Reporting and Analysis Unit 150. In some embodiments, the Tunneled Packet Filtering System 100 can include any number of packet inspection units sufficient to perform filtering on all or a portion of incoming data packets received at, for example, the Gateway Device 140.

In some embodiments, the Gateway Device 140 can be any combination of hardware and/or software (executing on hardware) configured to act as a central point of exchange for incoming data packets and/or filter policies within the Tunneled Packet Filtering System 100. As shown in FIG. 1, the Gateway Device 140 can exchange information with the External Network 170 and the Packet Inspection Units 130, receive information from the Policy Unit 110 and transmit information to the Reporting and Analysis Unit 150. For example, in some embodiments the Gateway Device 140 can receive one or more incoming data packets from the External Network 170, and one or more filter policies from the Policy Unit 110. In such embodiments, the Gateway Device 140 can transmit the one or more incoming data packets received from the External Network 170 to one or more of the Packet Inspection Units 130 for application of filter polices and/or rules. In some embodiments, the Gateway Device 140 can be further configured to receive filter results and/or events from one or more of the Packet Inspection Units 130. The Gateway Device 140 can additionally transmit information associated with filter results and/or events to the Reporting and Analysis Unit 150. Although not shown in FIG. 1, in some embodiments the Gateway Device 140 can transmit information to the Policy Unit 110 and/or receive information from the Reporting and Analysis Unit 150.

In some embodiments, the Gateway Device 140 can be a hardware device, such as a server device operatively and/or physically coupled to the Policy Unit 110. In some embodiments, the Gateway Device 140 can include or comprise one or more devices included in the Tunneled Packet Filtering System 100 (such as the Policy Unit 110, one or more of the Packet Inspection Units 130 and/or the Reporting and Analysis Unit 150). In some embodiments, the Gateway Device 140 can be or be included in a single hardware device, and/or be included in a single or multiple hardware devices along with one or more of the Policy Unit 110, one or more of the Packet Inspection Units 130 and/or the Reporting and Analysis Unit 150. In some embodiments, the Gateway Device 140 can be one of multiple such gateway devices included on the periphery of the Client Network 160, the gateway devices being configured to provide routing and/or other administrative functionality for the Client Network 160. In some embodiments, the Gateway Device 140 can be coupled to one or more of the above-mentioned devices via one or more wired and/or wireless data connections, such as connections conforming to one or more known information exchange standards, such as wired Ethernet, wireless 802.11x (“Wi-Fi”), WiMax, Ultra-wideband (UWB), Universal Serial Bus (USB), Bluetooth, infrared, Code Division Multiple Access (CDMA), Time Division Multiple Access (TDMA), Global Systems for Mobile Communications (GSM), Long Term Evolution (LTE), and the like.

The Reporting and Analysis Unit 150 can be any combination of hardware and/or software (executing on hardware) configured to receive information associated with filter results and/or events from the Gateway Device 140 and provide reporting and analysis to a user and/or administrator of the Tunneled Packet Filtering System 100. For example, the Reporting and Analysis Unit 150 can provide, via a text, graphical and/or web-based interface, reporting information associated with block and/or allow decisions made by the Packet Inspection Units 130 on incoming data packets. In some embodiments, the reporting and analysis can include aggregated trend information in the form of charts, graphs and the like. In some embodiments, the reporting and analysis can include alert and/or other information designed to notify a user of a particular filtering or network traffic event, such as a suspected attack or atypical amount or type of incoming traffic.

The Client Network 160 can be any computing network. For example, the Client Network 160 can be a local area network (LAN), wide area network (WAN), virtual local area network (VLAN), intranet, or extranet. In some embodiments, the Client Network 160 can include one or more of: switching and/or routing devices, server and/or client devices, peripheral devices, mobile computing devices, telephony devices, and the like. As shown in FIG. 1, one or more devices included in the Client Network 160 (not shown in FIG. 1) can receive one or more filtered data packets from any of the Packet Inspection Units 130.

In some embodiments, the Policy Unit 110 can receive, via user input, information sufficient to define one or more filter policies. For example, the Policy Unit 110 can receive user input that defines a filter policy stipulating that incoming data packets with improperly formed headers and/or excessively tunneled payloads should be blocked. In another example, a filter policy can stipulate that an IPv4 packet including an AH tunnel should have its AH headers removed and be sent for further IPv4 processing before ultimately being allowed into or blocked from the Packet Inspection Network 120.

Upon receipt and/or definition of a filter policy, the Policy Unit 110 can transmit information associated with the filter policy to the Gateway Device 140. In some embodiments, the Policy Unit 110 can transmit the information according to a preselected or predefined policy update schedule. Alternatively or additionally, in some embodiments, the Policy Unit 110 can transmit the information associated with the new filter policy immediately, or after a specified delay period.

Upon receipt of the filter policy information, the Gateway Device 140 can translate the filter policy into a format and/or set of one or more commands that can be interpreted and applied by the Packet Inspection Units 130. In some embodiments, the Gateway Device 140 can then transmit the translated filter policy information to the Packet Inspection Units 130 for use in filtering incoming data packets. In some embodiments, the Gateway Device 140 can also receive one or more incoming data packets from the External Network 170 and forward at least one of the incoming data packets to, for example, the Packet Inspection Unit 136. Each incoming data packet can be, for example, an Internet Protocol version 4 (IPv4) or Internet Protocol version 6 data packet.

In some embodiments, the Packet Inspection Unit 136 (or any of the Packet Inspection Units 130) can receive the translated filter policy information from the Gateway Device 140. In such embodiments, the Packet Inspection Unit 136 can then receive at least a portion of an incoming data packet from the Gateway Device 140 and apply one or more rules derived from the translated filter policy information to the incoming data packet. For example, in some embodiments the Packet Inspection Unit 136 can analyze a header and/or a payload of the incoming data packet and determine whether or not the incoming data packet meets or violates the one or more rules included in or derived from the translated filter policy information. In some embodiments, the Packet Inspection Unit 136 can detect one or more tunneled packets, i.e., packets encapsulated within the payload of the incoming data packet. In such embodiments, the Packet Inspection Unit 136 can apply the one or more rules on at least a portion of the tunneled packet, such as a header and/or payload of the tunneled packet, or, optionally, a second tunneled packet included in the payload of the initial tunneled packet. In some embodiments, the Packet Inspection Unit 136 can successively detect and analyze tunneled packets encapsulated and/or included in successive encapsulation layers or levels of the incoming data packet.

Upon completion of the analysis, the Packet Inspection Unit 136 can transmit a filter result and/or event to the Gateway Device 140. The filter result can indicate, for example, whether the incoming data packet has satisfied a set of conditions specified by the filter policy described above. For example, the filter result can indicate whether the incoming data packet met or failed to meet particular conditions stipulated by the filter policy. In some embodiments, the filter result can include an instruction based at least in part on the analysis, such as an instruction for the Gateway Device 140 to block at least a portion of the incoming data packet from entering the Packet Inspection Network 120. In some embodiments, the Packet Inspection Unit 136 can transmit the filter result upon completion of the analysis, after a preselected or calculated delay period, or along with one or more other filter results after a preselected quantity of filter results have been calculated.

In some embodiments, the Gateway Device 140 can receive the filter result from the Packet Inspection Unit 136 and take action responsive thereto. For example, if the Gateway Device 140 receives a filter result indicating a failed rule condition and/or indicating a block action, the Gateway Device 140 can block the incoming data packet from entering the Packet Inspection Network 120. In some embodiments, the Gateway Device 140 can block a first portion of the incoming data packet and allow a second portion of the incoming data packet to enter the Packet Inspection Network 120 via one or more network devices (not shown in FIG. 1).

The Gateway Device 140 can additionally be configured to transmit an indication of the filter result and/or the action taken responsive thereto to the Reporting and Analysis Unit 150. In some embodiments, the Gateway Device 140 can transmit the indication upon receipt of the filter result, after having taken the responsive action described above, in accordance with a preselected or predefined schedule, upon receipt of a threshold number of filter results, and/or upon receipt of a threshold number of positive or negative filter results.

In some embodiments, the Reporting and Analysis Unit 150 can receive the indication of the filter result and include it in a log or other record associated with the Tunneled Packet Filtering System 100. For example, the Reporting and Analysis Unit 150 can store the indication and/or information associated with and/or derived from the indication at a memory, such as a database (not shown in FIG. 1) included in and/or physically or operatively coupled to the Reporting and Analysis Unit 150. In some embodiments, the Reporting and Analysis Unit 150 can perform one or more analyses and/or generate one or more reports, charts and/or graphs based at least in part on the indication. In such embodiments, the Reporting and Analysis Unit 150 can provide an interface, such as a web-based interface, whereby a user of the Tunneled Packet Filtering System 100 can access information associated with the indication and/or the analysis and reporting information based thereon as described above.

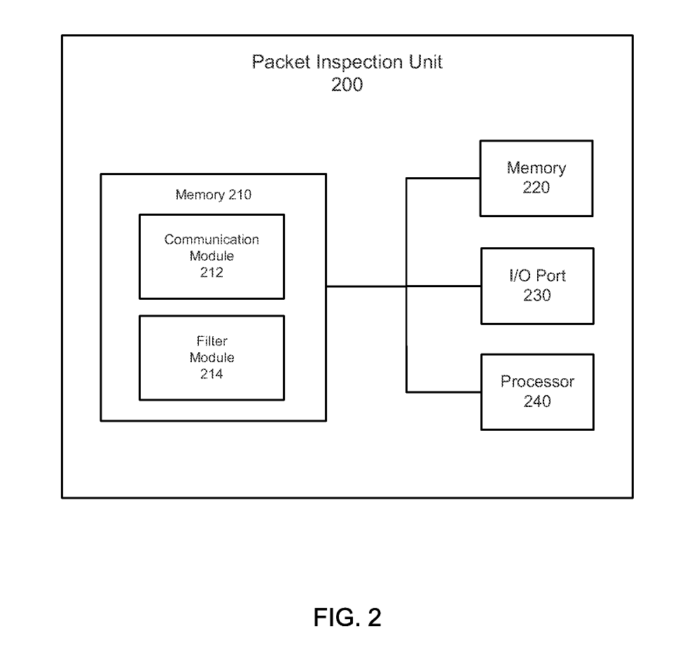

FIG. 2 is a schematic diagram that illustrates a packet inspection unit, according to an embodiment. More specifically, FIG. 2 illustrates Packet Inspection Unit 200 including a Memory 210, a Memory 220, an Input/Output (“I/O”) Port 230 and a Processor 240. The Memory 210 includes a Communication Module 212 and a Filter Module 214. As shown in FIG. 2, each of the Communication Module 212 and the Filter Module 214 can be in communication with each of the Memory 220, the I/O Port 230 and/or the Processor 240. As also shown in FIG. 2, each of the Memory 220, the I/O Port 230 and the Processor 240 can be in communication with one another.

The Packet Inspection Unit 200 can be any combination of hardware components and/or devices configured to receive and apply filter policies to incoming data packets. For example, in some embodiments the Packet Inspection Unit 200 can be a hardware device, such as a server device or system included in, in communication with and/or connected to a network, (not shown in FIG. 2), such as a LAN, a WAN, an extranet, intranet, or the Internet. The Packet Inspection Unit 200 can optionally be configured to receive one or more incoming data packets from a network device (not shown in FIG. 2) and apply one or more filter policies thereon. In some embodiments, the Packet Inspection Unit 200 can store the one or more filter policies in a memory, such as the Filter Module 214 included in the Memory 210. In some embodiments, the Packet Inspection Unit 200 can receive one or more filter policies from another device, such as a gateway device as discussed in connection with FIG. 1 above.

The Memory 210 can be any valid memory, such as, for example, a read-only memory (ROM) or a random-access memory (RAM). In some embodiments, the Memory 210 can be, for example, any type of processor-readable media, such as a hard-disk drive, a compact disc read-only memory (CD-ROM), a digital video disc (DVD), a Blu-ray disc, a flash memory card, or other portable digital memory type. The Memory 210 can optionally be configured to send signals to and receive signals from the Memory 220, the I/O Port 230, and/or the Processor 240.

The Communication Module 212 can be any valid combination of hardware and/or software (executing on hardware) configured to transmit and receive data packet, filter policy and/or filter result information. In some embodiments, the Communication Module 212 can exchange data packet, filter policy and/or filter result information with the Filter Module 214. In some embodiments, the Communication Module 212 can receive incoming data packet and filter policy information from, and transmit filter result information to, the I/O Port 230.

The Filter Module 214 can be any valid combination of hardware and/or software (executing on hardware) configured to inspect one or more incoming data packets and apply one or more filter policies thereon. In some embodiments, the Filter Module 214 can exchange data packet, filter policy and/or filter result information with the Communication Module 212. In some embodiments, the functionality performed by the Filter Module 214 can optionally be performed by two distinct modules, such as an inspection module (not shown in FIG. 2) and a filter module. In such embodiments, the inspection module can inspect an incoming data packet or data packet portion to identify characteristics of the incoming data packet or data packet portion, such as header length, header contents, payload length, payload contents, one or more protocols specified by the data packet header, the presence or absence of encapsulated packets in the data packet payload, etc. In such embodiments, the filter module can apply one or more filter policies to the inspected data packet or data packet portion to make a block or allow determination.

The Memory 220 can be any valid memory, such as, for example, a read-only memory (ROM) or a random-access memory (RAM). In some embodiments, the Memory 220 can be, for example, any type of processor-readable media, such as a hard-disk drive, a compact disc read-only memory (CD-ROM), a digital video disc (DVD), a Blu-ray disc, a flash memory card, or other portable digital memory type. The Memory 220 can optionally be configured to send signals to and receive signals from the Memory 210, the I/O Port 230, and/or the Processor 240.

The I/O Port 230 can be any valid combination of hardware and/or software (executing on hardware) configured to receive information at and transmit data from the Packet Inspection Unit 200. In some embodiments, the I/O Port 230 can be a hardware network communication device and/or a software module configured to format and transmit data to and from the hardware communication device. For example, in some embodiments, the I/O Port 230 can include network interface card (NIC), such as a wired and/or wireless Ethernet card, and an associated software device driver. As shown in FIG. 2, the I/O Port 230 can also transmit signals to and receive signals from the Memory 210, the Memory 220 and/or the Processor 240.

The Processor 240 can be any valid hardware processor configured to execute instructions, such as computing instructions included in and/or defined by the Communication Module 212 and/or the Filter Module 214. The Processor 240 can be, for example, an application-specific integrated circuit (ASIC), a digital signal processor (DSP), a field programmable gate array (FPGA), etc. As shown in FIG. 2, the Processor 240 can transmit signals to and receive signals from the Memory 210, the Memory 220 and/or the I/O Port 230. In some embodiments, the Processor 240 can access computing instructions in the Memory 220 for execution at the Processor 240 and then transmit information, including computed results, to the Memory 220.

In some embodiments, the I/O Port 230 can receive at least one filter policy from, for example, a policy unit and/or gateway device as discussed in connection with FIG. 1 above. The I/O Port 230 can then transmit the filter policy to the Communication Module 212 for subsequent transmission to the Filter Module 214. In some embodiments, the Filter Module 214 can already include one or more filter policies, the filter policies having been loaded at a previous time, such as during an initial device setup and/or software installation.

In some embodiments, the I/O Port 230 can receive at least one incoming data packet from, for example, a gateway device (as discussed in connection with FIG. 1 above). The I/O Port 230 can then transmit the incoming data packet to the Filter Module 214 via the Communication Module 212. In some embodiments, the incoming data packet can be, for example, an IPv4 packet, an IPv6 packet, or other known data packet type. The incoming data packet can contain a header and/or a payload as required by its data packet type or definition. For example, when the incoming data packet is an IPv4 data packet, the incoming data packet can include a variable-length header and a variable-length payload. The payload can optionally include data, such as application data and/or a tunneled (i.e., encapsulated packet).

The Filter Module 214 can next determine whether one or more conditions specified by a given filter policy are satisfied by the incoming data packet or a portion of the incoming data packet. In some embodiments, the Filter Module 214 can then apply the filter policy to determine whether the data packet or data packet portion should be allowed into the network, blocked from the network, or sent to another module or device for further processing. In some embodiments, the Filter Module 214 can determine that a portion of the incoming data packet, such as a payload of the incoming data packet, should be sent to another portion of code included in the Filter Module 214 for further processing. In such embodiments, the Filter Module 214 can then transmit, via the Communication Module 212 and the I/O Port 230, a filter result associated with the determination. The filter result can include, for example, an indication that the data packet or data packet portion did or did not satisfy all requirements of a filter policy applied thereto or thereon. In some embodiments, the filter result can include an indication that the incoming data packet or incoming data packet portion should or should not be allowed into the network. In such embodiments, the filter result can include an “allow” or “block” indicator configured or formatted to instruct a device, such as a gateway device, to accordingly allow or block the incoming data packet or incoming data packet portion.

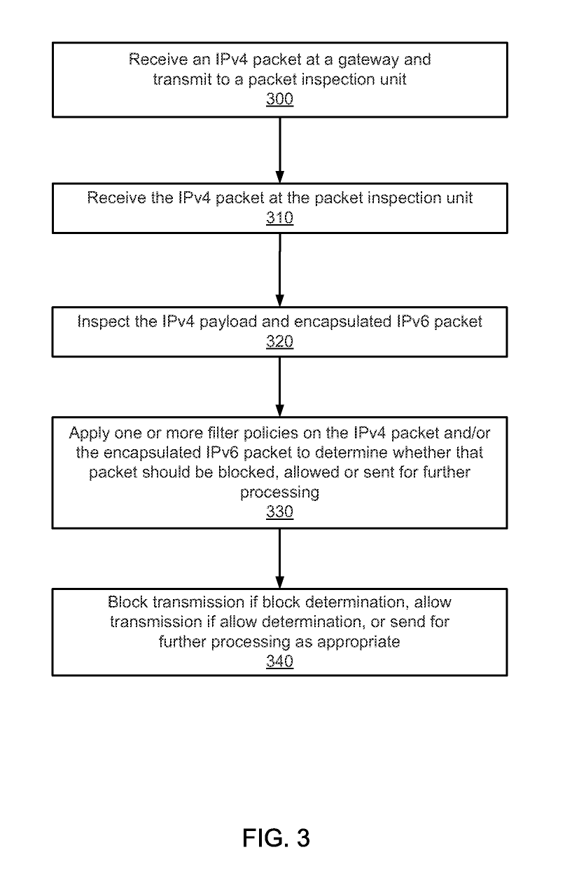

FIG. 3 is a flow chart that illustrates a method of filtering a tunneled packet encapsulated within an IPv4 packet based on one or more filter policies, according to an embodiment. More specifically, FIG. 3 illustrates a method of applying one or more filter policies to an IPv6 packet tunneled or encapsulated within the payload of an IPv4 packet.

As shown in FIG. 3, an IPv4 packet can be received at a gateway and transmitted thereby to a packet inspection unit, at 300. In some embodiments, the IPv4 packet can be an incoming data packet formatted and defined according to the IPv4 specification (as defined by IETF RFC 791). In such embodiments, the IPv4 packet can include a header and a payload, the header including packet addressing and other information. The gateway can be, for example, a network gateway device (e.g., Gateway Device 140 as discussed in connection with FIG. 1 above) situated on the periphery of a computer network, such as a LAN, VLAN, WAN, intranet or extranet. The packet inspection unit (e.g., Packet Inspection Unit 122 as discussed in connection with FIG. 1 above) can be, for example, a hardware-based device that includes software (executing on hardware) configured to inspect and apply filter policies on incoming data packets. In some embodiments, the gateway can send the IPv4 packet to the packet inspection unit via a wired or wireless connection or link, such as a wired Ethernet or wireless Ethernet (802.11x, or “Wi-Fi”) connection.

The packet inspection unit can receive the IPv4 packet, at 310. In some embodiments, the packet inspection unit can include one or more hardware and/or software modules configured to receive incoming data packet and/or filter policy information from another device or module. For example, the packet inspection unit can include a network interface card (NIC) and/or one or more software modules to transmit data to and from the NIC.

The packet inspection unit can inspect a payload of the IPv4 packet, at 320. More specifically, the packet inspection unit can inspect an encapsulated IPv6 packet included in the IPv4 payload. For example, the packet inspection unit can determine a length of a header of the IPv4 packet so as to determine a location within the IPv4 packet of the IPv4 payload. Based on the location of the IPv4 payload, the packet inspection unit can then determine the location of the encapsulated IPv6 packet included within the IPv4 payload. Having determined the location of the encapsulated IPv6 packet, the packet inspection unit can, for example, determine source and destination address, port, extension header and/or payload information of the encapsulated IPv6 packet.

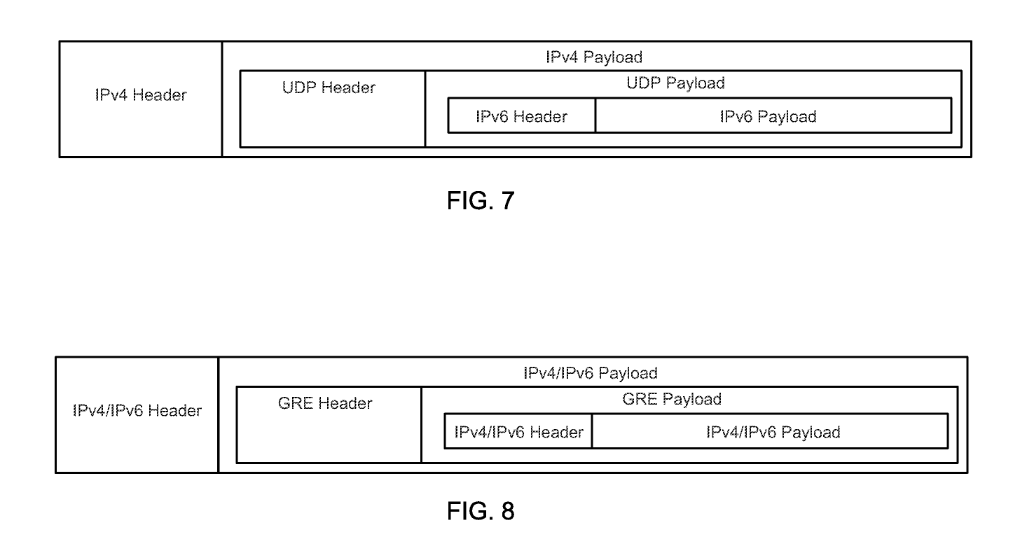

The packet inspection unit can apply one or more filter policies on or to the IPv4 packet and/or the encapsulated IPv6 packet, at 330. For example, the packet inspection unit can apply a filter policy concerned with a port number of the encapsulated IPv6 packet, and/or a filter policy configured to determine whether the encapsulated IPv6 packet is a potentially malicious IPv6-in-UDP, GRE or other data packet. (For examples of IPv6-in-UDP and GRE IPv4 packets, see FIGS. 7 and 8, respectively.) In some embodiments, the packet inspection unit can apply a filter policy configured to detect 6in4 packets. In such embodiments, the packet inspection unit can determine whether a protocol of the received IPv4 packet is equal to a preselected value, such as 41. If the protocol does equal 41, the packet inspection unit can conclude that the received IPv4 packet is a 6in4 packet, and can accordingly discard the header of the IPv4 packet and conclude that the payload of the IPv4 packet (i.e., the encapsulated IPv6 packet) should be sent for further processing.

In some embodiments, the packet inspection unit can apply a filter policy configured to detect Tunnel Setup Protocol (TSP) packets. In such embodiments, the packet inspection unit can determine whether a protocol of the received IPv4 packet is equal to a first preselected value, such as 17 (i.e., the protocol value for User Datagram Protocol, or “UDP”), and whether a destination port of the IPv4 packet is equal to a second preselected value, such as 3653. If the protocol does equal 17 and the destination port does equal 3653, the packet inspection unit can determine that the received IPv4 packet is a TSP packet, and can accordingly discard the header of the IPv4 packet and determine that the payload of the IPv4 packet (i.e., the encapsulated IPv6 packet) should be sent for further processing.

In some embodiments, the packet inspection unit can apply a filter policy configured to detect IPinIP packets. In such embodiments, the packet inspection unit can determine whether a protocol of the IPv4 packet has a preselected value of 4. If the protocol does have a preselected value equal 4, the packet inspection unit can conclude that the received IPv4 packet is an IPinIP packet, and can accordingly discard the header of the IPv4 packet and conclude that the payload of the IPv4 packet (i.e., the encapsulated IPv6 packet) should be sent for further processing.

In some embodiments, the packet inspection unit can apply a filter policy configured to detect Authentication Header (AH) tunneled packets. In such embodiments, the packet inspection unit can determine whether a protocol of the IPv4 packet has a preselected value of 51 and the value of the AH Next Header is a preselected value of 4. If the protocol does have a preselected value equal to 51 and the value of the AH Next Header is a preselected value of 4, the packet inspection unit can conclude that the IPv4 packet includes an AH-tunneled IPv4 packet, and can calculate the length of the AH header. By using the calculated AH header length, the packet inspection unit can next determine the end location of the IPv4 packet header and the AH header, and discard both headers so that the remaining IPv4 payload information (i.e., the encapsulated IPv6 packet) can be sent for further IPv4 processing.

In some embodiments, if the protocol of the IPv4 packet has a preselected value of 51 and the value of the AH Next Header has a preselected value of 41, the packet inspection unit can determine that the IPv4 packet includes an AH-tunneled IPv6 packet. In such embodiments, the packet inspection unit can calculate a length of the AH header as described above, and accordingly discard both the IPv4 and AH headers to allow the remaining IPv4 payload information (i.e., the encapsulated IPv6 packet) to be sent for further IPv6 processing.

Based on this application of filter policy(ies) at 330, the packet inspection unit can generate a block, allow, or further processing determination. For example, if the encapsulated IPv6 packet violates one or more applied filter policies, the packet inspection unit can determine that the encapsulated IPv6 packet should be blocked from the network. If the encapsulated IPv6 packet does not violate any applied filter policies, the packet inspection unit can determine that the encapsulated IPv6 packet should be allowed into the network. If the encapsulated IPv6 packet does not violate any applied filter policies but requires further processing, the packet inspection unit can send the encapsulated IPv6 packet to another module and/or device for further processing.

The packet inspection unit can next take appropriate action based on the determination, at 340. More specifically, the packet inspection unit can block the encapsulated IPv6 packet if it has determined that the IPv6 packet should be blocked as discussed in connection with step 330 above. The packet inspection unit can allow the encapsulated IPv6 packet if it has determined that the IPv6 packet should be allowed as discussed in connection with step 330 above. In some embodiments, when allowing an encapsulated IPv6 packet, the packet inspection unit can remove a header of the encapsulated IPv6 packet, transmitting only the payload of the encapsulated IPv6 packet to, for example, the gateway device discussed above. Alternatively, in some embodiments the packet inspection unit can transmit only the block or allow determination to the gateway device, where the appropriate action can be performed on the IPv4 and/or encapsulated IPv6 packet. As described above, in some embodiments the packet inspection unit can transmit all or a portion of a tunneled (i.e., encapsulated) packet to an IPv4 and/or IPv6 processing module (not shown) for further processing. In some embodiments, the IPv4 and/or IPv6 processing module can be a separate software-based and/or hardware-based module or device running software configured to further inspect, analyze, examine and/or filter a received data packet or data packet portion. In some embodiments, the IPv4 and/or IPv6 processing module can be included on or physically or operatively coupled to the packet inspection unit.

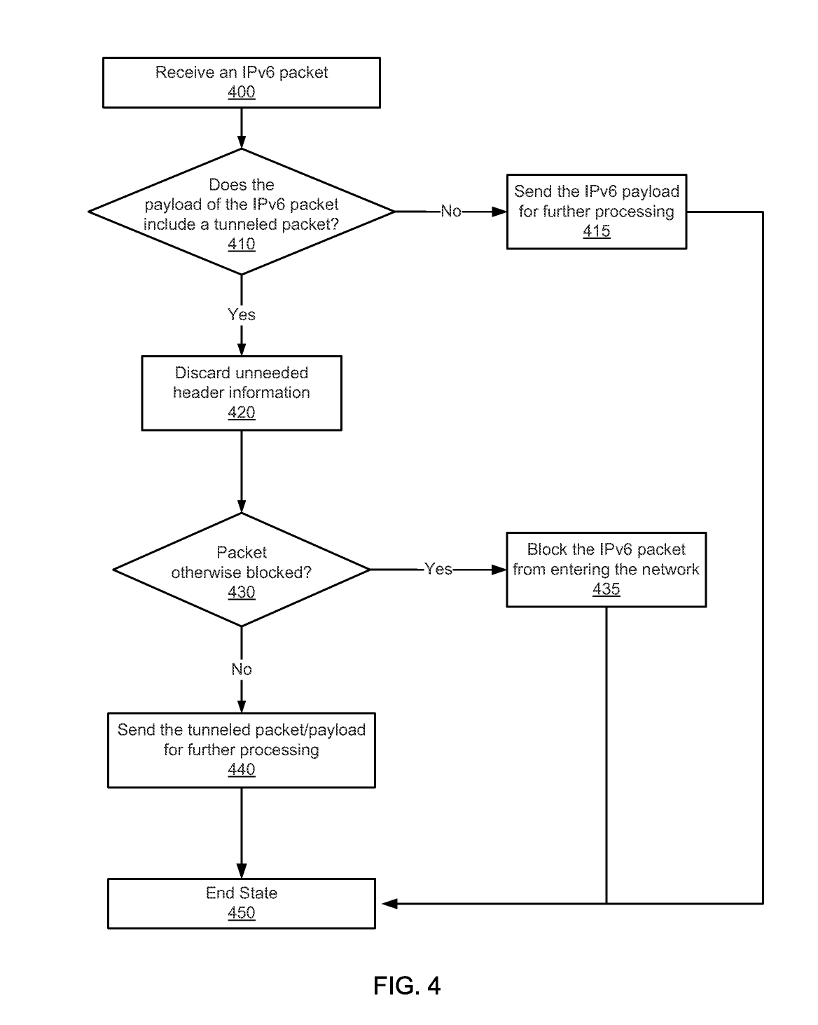

FIG. 4 is a flow chart that illustrates a method of filtering a tunneled packet encapsulated within an IPv6 packet based on one or more filter policies, according to an embodiment.

As shown in FIG. 4, an IPv6 packet can be received, at 400. In some embodiments, the IPv6 packet can be received at a gateway device (e.g., the Gateway Device 140 discussed in connection with FIG. 1) and transmitted thereby to a packet inspection unit (e.g., the Packet Inspection Unit 122 discussed in connection with FIG. 1). In some embodiments, the IPv6 packet can be an incoming data packet formatted and defined according to the IPv6 specification (defined by IETF RFC 2460). In such embodiments, the IPv6 packet can include a header and a payload, the header including packet addressing and other information.

The packet inspection unit can determine if the IPv6 packet includes a tunneled packet, at 410. In some embodiments, the packet inspection unit can inspect the payload of the IPv6 packet to detect, for example, an encapsulated IPv4, IPv6, and/or GRE packet. (For an example of an IPv4 or IPv6 packet that includes an encapsulated GRE packet, see FIG. 8. In FIG. 8, it should be understood that both the header and payload of a header/payload pair are of a same type. I.e., if the packet is an IPv4 packet, the payload of the packet is an IPv4 payload. Further, if the GRE-encapsulated packet is an IPv6 packet, the GRE-encapsulated payload is an IPv6 payload.) In examining the payload of the IPv6 packet, the packet inspection unit can, for example, determine a starting location of the payload based at least in part on a header of the IPv6 packet. In some embodiments, the inspection process can include determination of one or more protocols specified in the payload of the IPv6 packet and/or the detection or identification of one or more encapsulated headers in an IPv4, IPv6, and/or GRE format. In some embodiments, the inspection process can include detection of one or more preselected protocol values included in one or more extension headers of the IPv6 packet.

For example, if the IPv6 packet includes an extension header with a preselected value of 4, the packet inspection unit can conclude determine that the IPv6 packet includes an IPv4-in-IPv6 (“4in6”) tunneled packet. In some embodiments, if the IPv6 packet includes an extension header with a value of preselected 41, the packet inspection unit can determine that the IPv6 packet includes an IPv6-in-IPv6 (“6in6”) tunneled packet.

In some embodiments, if the IPv6 packet includes an extension header with a preselected value of 47, the packet inspection unit can conclude that the IPv6 packet may include a GREv6 tunnel. In this case, the packet inspection unit can then calculate a length of a GRE header of a GRE packet included in the payload of the IPv6 packet so as to determine a protocol of the tunneled (i.e., encapsulated) GRE packet. If the protocol of the tunneled GRE packet is either IPv4 or IPv6, the packet inspection unit can conclude that the IPv6 packet does include a GREv6 tunnel.

In some embodiments, if the IPv6 packet includes an extension header with a preselected protocol value of 51, the packet inspection unit can further inspect the IPv6 packet to determine if it includes an AH tunnel. For example, the packet inspection unit can determine if the value of the next Next Header (i.e., that following the extension header with protocol value 51) has the value preselected 4 or 41. If the next Next Header has the value 4 or 41, the packet inspection unit can conclude that the IPv6 packet may include an AH-tunneled IPv4 or IPv6 packet. In such embodiments, the packet inspection unit can optionally send the IPv6 payload to an initial IPv4 or IPv6 packet processing step or separate module, as appropriate. In some embodiments, the initial IPv4 or IPv6 processing step or module can be associated with another module or portion of the packet inspection unit or, alternatively another software-based or hardware-based module or device.

If the packet inspection unit does not detect a tunneled packet in the IPv6 packet, it can discard the header of the IPv6 packet and send the payload of the IPv6 packet for further processing, at 415. In some embodiments, the further processing can be performed by, for example, a software-based IPv6 packet processing module included on the packet inspection unit or another module or device. Upon performing this action, the packet inspection unit can proceed to an end state, such as end state 450.

If the packet inspection unit does detect a tunneled packet in the IPv6 packet, the packet inspection unit can discard unneeded header information of the IPv6 packet, at 420. For example, if the IPv6 packet includes a 4in6 packet or a 6in6 packet, the packet inspection unit can discard the header of the IPv6 packet. If the IPv6 packet includes a GREv6 packet, the packet inspection unit can discard the header of the IPv6 packet and the encapsulated GRE header.

The packet inspection unit can next determine if the IPv6 packet should be otherwise blocked, at 430. In some embodiments, the packet inspection unit can apply one or more additional filter policies to determine if the IPv6 packet should be otherwise blocked. For example, the packet inspection unit can determine whether the IPv6 packet includes other potentially malicious code, an illegally formed header or payload, or other illegal or out-of-range value.

If the packet inspection unit determines that the IPv6 packet should be blocked based on the application of one or more filter policies as described in connection with 430 above, it can block the IPv6 packet from entering the network, at 435. In some embodiments, the packet inspection unit can alternatively send a signal to the gateway device indicating that the IPv6 packet should be blocked. Having completed processing on the IPv6 packet, the packet inspection unit can proceed to an end state, at 450.

If the packet inspection unit determines that the IPv6 packet should not be otherwise blocked, it can send the tunneled packet or payload for further processing at 440. For example, if the packet inspection unit determines that the IPv6 packet includes a 4in6 packet, the packet inspection unit can send the 4in6 packet (i.e., the payload of the IPv6 packet) to an IPv4 processing module. In some embodiments, if the packet inspection unit determines that the IPv6 packet includes a 6in6 packet, the packet inspection unit can send the 6in6 packet (i.e., the payload of the IPv6 packet) to an IPv6 processing module. In some embodiments, if the packet inspection unit determines that the IPv6 packet includes a GREv6 packet specifying the IPv4 protocol, the packet inspection unit can send the payload of the GREv6 packet to the IPv4 processing module described above. Alternatively, if the packet inspection unit determines that the IPv6 packet includes a GREv6 packet specifying the IPv6 protocol, the packet inspection unit can send the payload of the GREv6 packet to the IPv6 processing module described above. In some embodiments, the IPv4 and/or IPv6 modules described above can be software-based and/or hardware-based modules. In some embodiments, the IPv4 and/or IPv6 modules can be included in and/or physically or operatively coupled to the packet inspection unit. In some embodiments, the IPv4 and/or IPv6 modules can be included in one or more other devices or modules included in the network, such as the ingress device described above.

Having sent the tunneled packet or payload for further processing, the packet inspection unit can complete processing of the IPv6 packet and enter the end state 450.

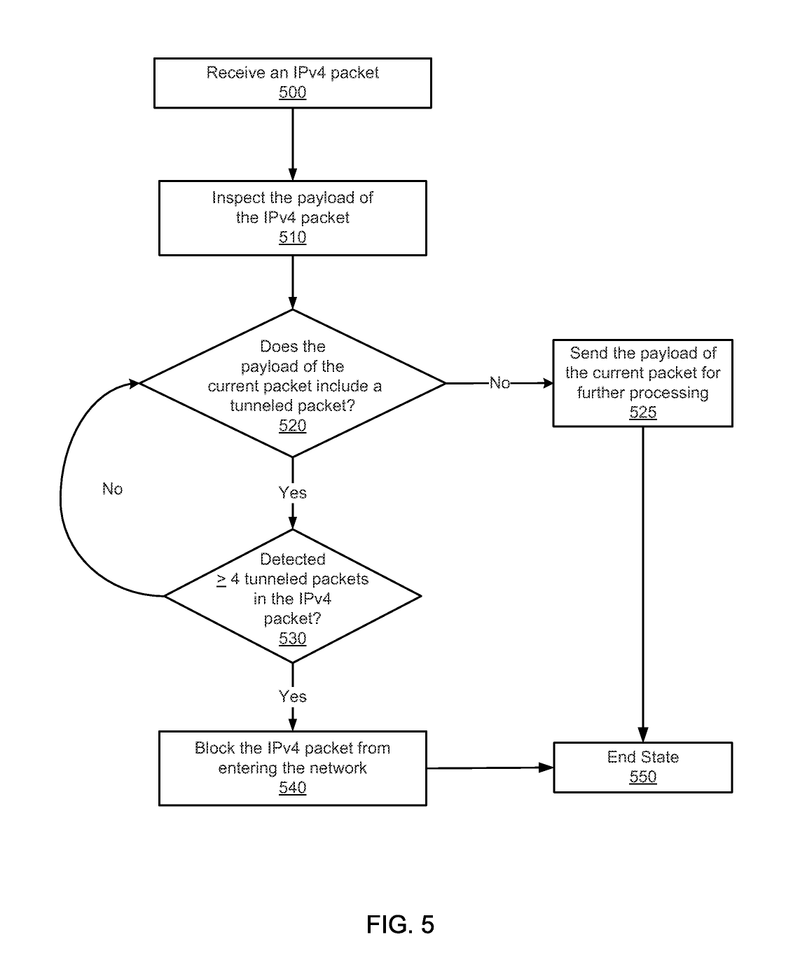

FIG. 5 illustrates a method of blocking a received IPv4 packet upon determination that the received IPv4 packet contains four or more tunneled packets, according to an embodiment.

As shown in FIG. 5, an IPv4 packet is received, at 500. In some embodiments, the IPv4 packet can be received at a module or device included in a network (e.g., the Packet Inspection Network 120 and/or the Client Network 160 discussed in connection with FIG. 1), such as a LAN, a VLAN, a WAN, an intranet or an extranet. The device can be an ingress device, such as, for example, a router or switching device, a gateway device (e.g., the Gateway Device 140 discussed in connection with FIG. 1 above), or other hardware-based and/or software-based module configured to receive incoming IPv4 packets on the ingress side of the network.

In some embodiments, the ingress device can inspect the payload of the IPv4 packet, at 510. Alternatively, the ingress device can forward the IPv4 packet for inspection of the payload at one or more packet inspection units, such as the Packet Inspection Units 120 discussed in connection with FIG. 1 above. In such embodiments, the ingress device can be operatively and/or physically coupled to the one or more packet inspection units via one or more wired and/or wireless data connections, such one or more of: a wired Ethernet, wireless 802.11x (“Wi-Fi”) connection, Fibre Channel or other connection. (Although the above-described inspection step and subsequent steps described below will be discussed as being performed by a packet inspection unit, it should be understood that in some embodiments any number of network devices, such as the ingress device discussed above, can perform any or all of the described steps.) In inspecting the payload of the current IPv4 packet, the packet inspection unit can, for example, determine a starting location of the payload based at least in part on a header of the IPv4 packet. In some embodiments, the inspection process can include determination of one or more protocols specified in the payload of the IPv4 packet.

The packet inspection unit can determine whether the payload of the current packet includes a tunneled packet, at 520. Upon initial execution of this step, the current packet can be the original IPv4 packet. As will be discussed below, in some embodiments this step can be performed iteratively by the packet inspection unit on successively encapsulated (i.e., tunneled) data packets included within the IPv4 packet.

By analyzing the payload of the current packet, the packet inspection unit can detect the presence of a tunneled packet located within the payload of the current packet. For example, the packet inspection unit can detect an encapsulated header and payload within the payload of the current packet, the encapsulated header and payload being, for example, an encapsulated IPv4 or IPv6 packet.

If the packet inspection unit determines that the current packet does not include a tunneled packet, it can send the payload of the current packet for further processing, at 525. For example, if the packet inspection unit determines that the current packet contains no encapsulated headers and/or payloads, it can send only the payload of the current packet for further processing by, for example, a software-based IPv4 packet processing module included on the packet inspection unit or another module or device. Upon performing this action, the packet inspection unit can proceed to an end state, such as end state 550.

If the packet inspection unit has detected a tunneled packet, the packet inspection unit can determine whether four or more tunneled packets have been detected in the IPv4 packet, at 530. For example, the packet inspection unit can increment and then reference a locally-stored or remotely-stored counter or other indicator to determine whether it has detected four or more tunneled packets within the IPv4 packet. In some embodiments, the packet inspection unit can determine whether any preselected number of tunneled packets have been detected within the IPv4 packet.

If the packet inspection unit has not detected four or more tunneled packets in the IPv4 packet, the packet inspection unit can return to step 520 (described above) to analyze the tunneled (current) packet just detected for inclusion of a further-tunneled packet encapsulated therein. This process of detecting a tunneled packet within a current packet and successively detecting further-tunneled packets can continue until four or more tunneled packets have been detected within the IPv4 packet or the packet inspection unit determines that a current packet does not include a further-tunneled packet (as discussed in connection with 520 and 525 above).

If the packet inspection unit has detected four or more tunneled packets within the IPv4 packet, the packet inspection unit can determine that the IPv4 packet should be blocked from entering the network, at 540. In some embodiments, the packet inspection unit can perform the block action itself. Alternatively, in some embodiments, the packet inspection unit at 540 can send a signal to the ingress device indicating that the IPv4 packet should be blocked from the network. In some embodiments, the packet inspection unit can then proceed to an end state, such as end state 550, to terminate processing on the received IPv4 packet.

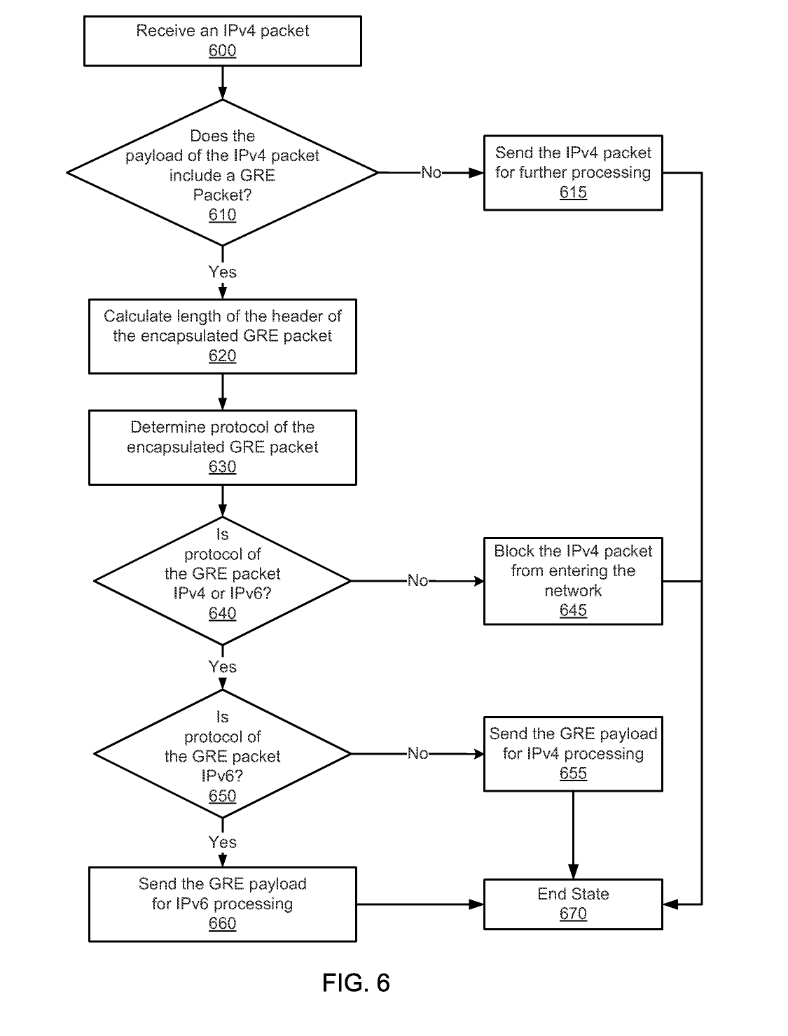

FIG. 6 is a flow chart that illustrates a method of filtering a tunneled Generic Routing Encapsulation (GRE) packet, according to an embodiment. More specifically, FIG. 6 illustrates a method of determining whether a received IPv4 packet contains a potentially malicious GRE packet, and blocking the received IPv4 packet if the determination is in the affirmative. Although a GRE packet filtering process is illustrated in FIG. 6 and will accordingly be the principal focus of the discussion below, other alternative filtering processes associated with other encapsulated packet types will also be discussed.

As shown in FIG. 6, an IPv4 packet is received, at 600. In some embodiments, the IPv4 packet can be received at a module or device included in a network, such as a LAN, a VLAN, a WAN, an intranet or an extranet. The device can be an ingress device, such as, for example, a router or switching device, a gateway device, or other hardware-based and/or software-based module configured to receive incoming IPv4 packets on the ingress side of the network.

In some embodiments, the ingress device can inspect the payload of the received IPv4 packet to determine if it includes a GRE packet, at 610. (For an example of a GRE packet, see FIG. 8.) Alternatively, the ingress device can forward the IPv4 packet for inspection of the payload at one or more packet inspection units, such as the packet inspection units discussed in connection with FIG. 1 above. In such embodiments, the ingress device can be operatively and/or physically coupled to a packet inspection unit via a wired and/or wireless data connection, such as a wired Ethernet, wireless 802.11x (“Wi-Fi”) connection, Fibre Channel connection, etc. (Although the above-described inspection step and subsequent steps described below will be discussed as being performed by a packet inspection unit, it should be understood that in some embodiments any number of network devices, such as the ingress device discussed above, can perform any or all of the described steps.) In some embodiments, the packet inspection unit can determine whether the IPv4 packet includes a GRE packet by determining whether a protocol of the IPv4 packet has a preselected value equal to 47. Alternatively, the ingress device can determine if the received IPv4 packet includes an IPv6-in-UDP packet. (For an example of an IPv6-in-UDP packet, see FIG. 7.) In such embodiments, the packet inspection unit can determine whether the IPv4 packet includes an IPv6-in-UDP packet by determining whether a protocol of the IPv4 packet has a preselected value of 17 (i.e., the protocol value for User Datagram Protocol, or “UDP”). In some embodiments, the packet inspection unit can determine whether a destination port of the IPv4 packet has a preselected value of 3544 to further confirm that the IPv4 packet includes an IPv6-in-UDP packet. In some embodiments, the IPv6-in-UDP packet can be, for example, a Teredo packet.

If the packet inspection unit concludes that the IPv4 packet does not include a GRE packet, the packet inspection unit can send the IPv4 packet for further processing by an IPv4 processing module, at 615. In some embodiments, if the packet inspection unit determines that the IPv4 packet does not contain an IPv6-in-UDP tunneled packet, the packet inspection unit can send the IPv4 packet for further processing by the IPv4 processing module. In some embodiments, the packet inspection unit can send only the payload of the IPv4 packet to the IPv4 processing module. As shown in FIG. 6, the packet inspection unit can then proceed to an end state, such as end state 670, and complete processing of the IPv4 packet.

If the packet inspection unit determines that the IPv4 packet does include a GRE packet, it can calculate the length of the header of the encapsulated GRE packet, at 620. More specifically, in some embodiments, the packet inspection unit can locate an end-of-header or other symbol or marker within the GRE packet that denotes the end of the GRE header and/or the start of the GRE payload. In some embodiments, the packet inspection unit can determine whether the IPv4 packet includes an IPv6-in-UDP packet, by first calculating the start location of an encapsulated UDP payload. In some embodiments, the calculating can be based at least in part on a total length of the received IPv4 packet, a length of a header of the received IPv4 packet, a length of a header of a UDP packet included in the received IPv4 packet and a length of a header of an IPv6 packet included in the UDP packet. The packet inspection unit can next determine whether any byte of the UDP payload has a value of 0x6 and shift right six bytes to calculate, determine and/or capture the IPv6 payload length. If this IPv6 payload length equals the sum of the IPv4 header length, IPv4 total packet length, UDP header length and IPv6 header length, then the packet inspection unit can conclude that the received IPv4 packet includes an IPv6 packet encapsulated within an encapsulated UDP packet, and thus includes an IPv6-in-UDP-tunneled packet.

Having determined the length of the GRE header, the packet inspection unit can determine a protocol of the GRE packet, at 630. For example, the packet inspection unit can inspect the GRE header to determine a protocol of the GRE packet. In some embodiments, if the received IPv4 packet includes an IPv6-in-UDP packet, the packet inspection unit can determine a source address and a destination address included in the header of the IPv6-in-UDP packet. The packet inspection unit can determine if the protocol of the encapsulated GRE packet is IPv4 or IPv6, at 640. In some embodiments, the packet inspection unit can do so by referencing the protocol identified in 630 above. In some embodiments, if the IPv4 packet includes an IPv6-in-UDP packet, the packet inspection unit can, at 630, determine whether the source and destination addresses of the IPv6-in-UDP packet are valid. In some embodiments, if the IPv4 packet includes an IPv6-in-UDP packet, the packet inspection unit can, at 630, next determine whether the payload of a tunneled IPv6 packet included within the IPv6-in-UDP packet is a valid IPv6 payload.

If the protocol of the GRE packet is not IPv4 or IPv6, the packet inspection unit can send a signal to block the IPv4 packet from entering the network, at 645. In some embodiments, this signal can be sent within the packet inspection unit so that the packet inspection unit blocks the IPv4 packet. In some other embodiments, the packet inspection unit can alternatively send a signal to the ingress device indicating that the IPv4 packet should be blocked by that ingress device. In such embodiments, the ingress device can block the IPv4 packet based at least in part on the signal received from the packet inspection unit. Having made the block determination and/or acted thereon, the packet inspection unit can enter an end state, at 670. In some embodiments, if the IPv4 packet includes an IPv6-in-UDP packet, the packet inspection unit can, at 645, block the IPv4 packet from entering the network if the source address and/or the destination address is invalid. In some embodiments, if the IPv4 packet includes an IPv6-in-UDP packet, the packet inspection unit can, at 645, block the IPv4 packet from entering the network if the payload of the encapsulated IPv6 packet is not a valid IPv6 payload. In some embodiments, the packet inspection unit can alternatively send a signal to the ingress device indicating that the IPv4 packet should be blocked. The packet inspection unit can then accordingly enter the end state 670.

If the protocol of the GRE packet is IPv4 or IPv6, the packet inspection unit can determine whether the protocol of the packet is IPv6, at 650. If the protocol of the GRE packet is not IPv6, the packet inspection unit can determine that the protocol is IPv4, and send the GRE payload for further IPv4 processing, at 655. In some embodiments, the packet inspection unit can send the GRE payload to a software-based and/or hardware-based module included in the packet inspection unit for the further IPv4 processing. In some embodiments, the packet inspection unit can send the GRE payload to another network module and/or device for performance of the IPv4 processing. Having done so, the packet inspection unit can enter the end state, 670. In some embodiments, if the IPv4 packet includes an IPv6-in-UDP packet and the packet inspection unit has determined that the source address and destination address are both valid, the packet inspection unit can send the IPv6-in-UDP packet for further IPv6 processing (not shown in FIG. 6). Having done so, the packet inspection unit can enter the end state, at 670.

If the protocol of the GRE packet is IPv6, the packet inspection unit can send the GRE payload for further IPv6 processing, at 660. In some embodiments, the packet inspection unit can send the GRE payload to a software-based and/or hardware-based module included in the packet inspection unit for the further IPv6 processing. In some embodiments, the packet inspection unit can send the GRE payload to another network module and/or device for performance of the IPv6 processing. Having completed processing of the IPv4 packet, the packet inspection device can enter the end state, at 670.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, in some embodiments a tunneled packet filtering system can include two or more gateway devices similar to the Gateway Device 140 discussed in connection with FIG. 1 above.

What is claimed is:

1. A non-transitory processor-readable medium storing code representing instructions to cause a processor to:
determine whether an IPv4 payload of an IPv4 packet includes a tunneled IPv6 packet;
when the IPv4 payload includes the tunneled IPv6 packet, determine a location of a payload of the tunneled IPv6 packet based at least in part on a header of the tunneled IPv6 packet; and
send a signal to block transmission of the IPv4 packet when the payload of the tunneled IPv6 packet is not a valid IPv6 payload.

2. The non-transitory processor-readable medium of claim 1, wherein the tunneled IPv6 packet is an IPv6-in-UDP packet.

3. The non-transitory processor-readable medium of claim 1, wherein the code to determine the location of the payload of the tunneled IPv6 packet includes code to calculate a length of the header of the tunneled IPv6 packet.

4. The non-transitory processor-readable medium of claim 1, wherein the code to determine the location of the payload of the tunneled IPv6 packet includes code to calculate a length of the header of the tunneled IPv6 packet based at least in part on:
a length of the IPv4 packet; and
a length of an IPv4 header of the IPv4 packet.

5. The non-transitory processor-readable medium of claim 1, wherein the code to determine whether the IPv4 payload includes the tunneled IPv6 packet includes code to determine whether the IPv4 payload includes a tunneled IPv6-in-UDP packet, the code including code to determine whether a protocol value of the IPv4 packet is a preselected protocol value and a destination port value of the IPv4 packet is a preselected port value.

6. The non-transitory processor-readable medium of claim 1, further comprising code to:
determine whether a protocol value of the IPv4 packet is a preselected protocol value;
determine whether a destination port value of the IPv4 packet is a preselected port value;
determine whether the header of the tunneled IPv6 packet is a valid IPv6 packet header;
determine whether the payload of the tunneled IPv6 packet includes a valid IPv6 source address and whether the payload of the tunneled IPv6 packet includes a valid IPv6 destination address; and
send a signal to block transmission of the IPv4 packet when:
the IPv4 protocol of the IPv4 packet is 17;
the header of the tunneled IPv6 packet is the valid IPv6 packet header; and
at least one of:
the payload of the tunneled IPv6 packet does not include the valid IPv6 source address; or
the payload of the tunneled IPv6 packet does not include the valid IPv6 destination address.

7. The non-transitory processor-readable medium of claim 1, further comprising code to:
send a signal to block transmission of the IPv4 packet when the tunneled IPv6 packet does not include a valid IPv6 payload.

8. The non-transitory processor-readable medium of claim 1, further comprising code to:
send a signal to block transmission of the tunneled IPv6 packet when a byte of a User Datagram Protocol (UDP) payload included in the IPv4 packet has a value of 0x6 and the payload of the tunneled IPv6 packet is not a valid IPv6 payload.

9. A non-transitory processor-readable medium storing code representing instructions to cause a processor to:
iteratively detect, at a module, a tunneled packet nested within a payload of an encapsulating data packet until a final tunneled packet is detected or the detect is repeated a preselected number of times; and
send a signal to block transmission of the tunneled packet if the module has performed the detecting a preselected number of times.

10. The non-transitory processor-readable medium of claim 9, the code further comprising code to:
allow transmission of at least the final tunneled packet when the final tunneled packet satisfies at least one allow rule from a plurality of allow rules.

11. The non-transitory processor-readable medium of claim 9, the code further comprising code to:
send a signal to block transmission of the final tunneled packet when the final tunneled packet satisfies at least one block rule from a plurality of block rules.

12. The non-transitory processor-readable medium of claim 9, the code further comprising code to:
send the final tunneled packet for further processing when:
the final tunneled packet does not satisfy at least one allow rule from a plurality of allow rules; and
the final tunneled packet does not satisfy at least one block rule from a plurality of block rules.

13. The non-transitory processor-readable medium of claim 9, wherein the code to iteratively detect includes code to determine when the payload of the encapsulating packet includes an encapsulated header.

14. The non-transitory processor-readable medium of claim 9, wherein the preselected number of times is four.

15. The non-transitory processor-readable medium of claim 9, further comprising code to:
send a signal to block transmission of the tunneled packets and the encapsulating packets when the module has performed the detect the preselected number of times.

16. An apparatus, comprising:
a communication module, the communication module configured to receive an IPv4 packet; and
a filter module, the filter module configured to: (1) determine if an IPv4 payload of the IPv4 packet includes a Generic Routing Encapsulation (GRE) packet, and (2) perform further processing on a payload of the GRE packet when a protocol of the GRE packet is IPv4 or IPv6.

17. The apparatus of claim 16, wherein the filter module is further configured to determine that the IPv4 payload includes the GRE packet when a protocol value of the IPv4 packet is a preselected protocol value.

18. The apparatus of claim 16, wherein the filter module is further configured to:
calculate a length of a header of the GRE packet based at least in part on a length of the IPv4 packet and a length of an IPv4 header of the IPv4 packet.

19. The apparatus of claim 16, wherein the filter module is further configured to:
determine the protocol of the GRE packet based at least in part on a length of a header of the GRE packet.

20. The apparatus of claim 16, wherein the filter module is further configured to send a signal to block transmission of the GRE packet when the GRE packet does not include a valid IPv4 payload or a valid IPv6 payload.

21. The apparatus of claim 16, wherein the further processing performed by the filter module includes:
sending the payload of the GRE packet to an IPv4 processing module when the protocol of the GRE packet is IPv4; and
sending the payload of the GRE packet to an IPv6 processing module when the protocol of the GRE packet is IPv6.
